(19) United States
(12) Patent Application Publication
(10) Pub. No.: US 2024/0097137 A1
(43) Pub. Date: Mar. 21, 2024

(54) BATTERY AND METHOD OF MANUFACTURING THE SAME

(71) Applicant: TOYOTA JIDOSHA KABUSHIKI KAISHA, Toyota-shi (JP)

(72) Inventor: Masaharu SENOUE, Seto-shi (JP)

(21) Appl. No.: 18/354,001

(22) Filed: Jul. 18, 2023

(30) Foreign Application Priority Data
Sep. 20, 2022 (JP) 2022-148857

(51) Int. Cl. H01M 4/62; H01M 4/04

(52) U.S. Cl. CPC H01M 4/625; H01M 4/0416; H01M 2004/027

(57) ABSTRACT

The battery includes a negative electrode composite material, a separator layer, a positive electrode composite material, a conductive layer, and a positive electrode current collector. A honeycomb structure of the negative electrode includes a first end surface, a second end surface, and a side wall. The side wall connects the first end surface and the second end surface. A plurality of through holes extending from the first end surface to the second end surface is formed. The separator layer covers at least a part of the inner wall of the through hole, and separates the positive electrode composite material from the negative electrode composite material. The positive electrode composite material is disposed inside the through hole. The conductive layer including a conductive material has a composition different from that of the positive electrode composite material, and connects the positive electrode composite material and the positive electrode current collector.

### CROSS-REFERENCE TO RELATED APPLICATION

This application claims priority to Japanese Patent Application No. 2022-148857 filed on Sep. 20, 2022 incorporated herein by reference in its entirety.

### BACKGROUND

### 1. Technical Field

The present disclosure relates to a battery and a method of manufacturing the same.

### 2. Description of Related Art

Japanese Unexamined Patent Application Publication No. 2020-123484 (JP 2020-123484 A) discloses a first electrode provided with a plurality of through holes and a second electrode filled in each through hole.

### SUMMARY

FIG. 1 is an explanatory diagram of an issue in an aspect of the present disclosure A negative electrode composite material 10 is formed into a predetermined shape. A plurality of through holes 2 is formed in the negative electrode composite material 10. The through hole 2 is provided with a first opening portion 2a and a second opening portion 2b. A separator layer 30 covers an inner wall of the through hole 2.

For example, a positive electrode paste 4 is press-fitted into the through hole 2 from the first opening portion 2a. When the positive electrode paste 4 is dried, the positive electrode composite material 20 is disposed inside the through hole 2. When the positive electrode paste 4 is dried, the positive electrode paste 4 may shrink. Due to the shrinkage of the positive electrode paste 4, a recessed portion 21 (a recess) may be generated in the positive electrode composite material 20. When the recessed portion 21 is formed at the tip of the positive electrode composite material 20, a connection between the positive electrode composite material 20 and a positive electrode current collector 25 becomes insufficient. Then, the battery resistance may increase.

An object of one aspect of the present disclosure is to reduce battery resistance.

A technical configuration and effects of the present disclosure will be described below. However, an effect mechanism of the present specification includes speculation. The effect mechanism does not limit the technical scope of the present disclosure.

1. A battery according to one aspect of the present disclosure includes: a negative electrode composite material containing a negative electrode active material; a separator layer; a positive electrode composite material containing a positive electrode active material; a conductive layer containing a conductive material; and a positive electrode current collector. The negative electrode composite material forms a honeycomb structure. The honeycomb structure includes a first end surface, a second end surface, and a side wall. The second end surface is a surface opposite to the first end surface. The side wall connects the first end surface and the second end surface. A plurality of through holes extending from the first end surface to the second end surface is provided. Each of the through holes includes a first opening portion that is open to the first end surface, and a second opening portion that is open to the second end surface. The separator layer covers at least a portion of an inner wall of the through hole. The separator layer separates the positive electrode composite material from the negative electrode composite material. The positive electrode composite material is disposed on an inside of the through hole. The conductive layer has a different composition from a composition of the positive electrode composite material. The positive electrode current collector is disposed outside the through hole. The conductive layer connects the positive electrode composite material and the positive electrode current collector.

The battery according to the above 1 includes a conductive layer. The conductive layer extends so as to connect the positive electrode composite material inside the through hole and the positive electrode current collector outside the through hole. Therefore, even when the recessed portion is formed at the tip end of the positive electrode composite material, the positive electrode composite material and the positive electrode current collector can be connected to each other. With the above, a reduction in battery resistance is expected.

2. In the battery according to the above 1, the conductive layer may be disposed so as to close at least one of the first opening portion and the second opening portion. When the conductive layer is formed so as to close the opening portion, the conductive layer is expected to fill in the recessed portion. When the conductive layer fills the recessed portion, the resistance between the positive electrode composite material and the positive electrode current collector is expected to be reduced.

3. In the battery according to the above 1 or 2, the positive electrode composite material may include a recessed portion. The recessed portion is recessed from the first opening portion or the second opening portion toward the inside of the through hole.

4. In the battery according to any one of the above 1 to 3, the conductive material may include, for example, at least one selected from the group consisting of a spherical carbon particle group, a discotic carbon particle group, and a rod-shaped carbon particle group.

5. In the battery according to any one of the above 1 to 4, the conductive material may have, for example, a sphere equivalent diameter of 10 μm or more.

For example, in the case where the conductive paste is applied, a short-circuit path may be formed when the conductive material penetrates into the separator layer. When the conductive material has the spherical equivalent diameter of 10 μm or more, the conductive material tends to hardly penetrate into the separator layer.

6. In the battery according to any one of the above 1 to 5, the conductive layer may further contain a binder. A mass ratio of the binder to the conductive material may be 0.2 or less.

The conductive paste containing a large amount of binder tends to shrink during drying. When the volume of the conductive paste is greatly changed, a shrinkage stress is generated in the conductive layer. As a result, cracks may occur in the separator layer adjacent to the conductive layer. Cracks in the separator layer can cause short circuit. When the mass ratio of the binder to the conductive material is 0.2 or less, cracks tend to hardly occur in the separator layer. This is considered to be because the volume change of the conductive paste becomes small.

7. In the battery according to any one of the above 1 to 6, the conductive layer may not contain the positive electrode active material.

As long as the conductive layer has a composition different from that of the positive electrode composite material, the conductive layer may contain the positive electrode active material. However, in general, the positive electrode active material is more expensive than the conductive material. When the conductive layer does not contain the positive electrode active material, the manufacturing cost is expected to be reduced.

8. In the battery according to any one of the above 1 to 7, the conductive layer may be disposed so as to close the first opening portion or the second opening portion.

In the battery according to the above 8, the positive electrode current collector may be disposed on one of the first end surface and the second end surface.

9. In the battery according to any one of the above 1 to 7, the conductive layer may be disposed so as to close the first opening portion and the second opening portion.

In the battery according to the above 9, the positive electrode current collector may be disposed on both the first end surface and the second end surface. Due to the increase in the current collecting area, a reduction in battery resistance is expected.

10. A method of manufacturing a battery according to one aspect of the present disclosure, the battery using a honeycomb structure as a base material, the honeycomb structure including a first end surface, a second end surface, a side wall, and a plurality of through holes, the second end surface being a surface opposite to the first end surface, the side wall connecting the first end surface and the second end surface, the through holes extending from the first end surface to the second end surface, each of the through holes including a first opening portion that is open to the first end surface and a second opening portion that is open to the second end surface, the method includes executing, in the following order, processes including:
(a) forming a negative electrode composite material containing a negative electrode active material into the honeycomb structure;
(b) covering at least a portion of an inner wall of the through hole by a separator layer;
(c) disposing a positive electrode composite material inside the through hole by pushing a positive electrode paste into the through hole from the first opening portion or the second opening portion, the positive electrode composite material containing a positive electrode active material;
(d) forming a conductive layer in contact with the positive electrode composite material by applying a conductive paste to at least one of the first opening portion and the second opening portion; and
(e) adhering a positive electrode current collector to the conductive layer from an outside of the through hole, the conductive layer containing a conductive material and having a composition different from a composition of the positive electrode composite material.

11. In the method according to the above 10, the positive electrode paste may be pushed into the through hole from the first opening portion, and the conductive layer may be formed by applying the conductive paste to at least the second opening portion.

Compared to the side (inlet side) where the positive electrode paste is pushed in, there is a tendency that a conduction failure between the positive electrode composite material and the positive electrode current collector is likely to occur on the outlet side. It is considered that shrinkage of the positive electrode paste is likely to occur on the outlet side during drying. When the conductive layer is disposed at least on the outlet side, a reduction in battery resistance is expected.

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an illustration of a problem in one aspect of the present disclosure;

FIG. 2 is a schematic diagram illustrating an example of a battery according to the present embodiment;

FIG. 3 is a schematic diagram of a power generation element in the present embodiment;

FIG. 4 is a schematic diagram illustrating an example of a negative electrode composite material in the present embodiment;

FIG. 5 is a schematic cross-sectional view of a power generation element according to the present embodiment;

FIG. 6 is a schematic flowchart of a method of manufacturing a battery according to the present embodiment;

FIG. 7 is a first optical micrograph showing a manufacturing process of the cell according to the present embodiment; and

FIG. 8 is a second optical micrograph showing a manufacturing process of the battery according to the present embodiment.

### DETAILED DESCRIPTION OF EMBODIMENTS

### Terms and Definitions

Statements of “comprising,” “including,” and “having,” and variations thereof (for example “composed of”) are open-ended formats. The open-ended format may or may not include an additional element in addition to a required element. A statement of “consisting of” is a closed format. However, even when the statement is the closed format, normally associated impurities and additional elements irrelevant to the disclosed technique are not excluded. The statement “consisting essentially of” is in semi-closed form. The semi-closed format allows addition of an element that does not substantially affect the basic and novel characteristics of the disclosed technique.

“At least one of A and B” includes “A or B” and “A and B”. “At least one of A and B” may also be referred to as “A and/or B.”

Expressions such as “may” and “can” are used in the permissive sense of “having the possibility of” rather than in the obligatory sense of “must”.

Geometric terms (for example, “parallel”, “perpendicular”, and “orthogonal”) are not to be taken in a strict sense. For example, “parallel” may deviate somewhat from “parallel” in a strict sense. Geometric terms may include, for example, design, work, manufacturing tolerances, errors, etc. Dimensional relationships in each drawing may not match actual dimensional relationships. Dimensional relationships (length, width, thickness, etc.) in the drawings may be changed to facilitate understanding of the reader. Further, a part of the configuration may be omitted.

Numerical ranges such as “m to n %” include upper and lower limits unless otherwise specified. That is, “m to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

All numerical values are modified by the term “approximately.” The term “approximately” can mean, for example, ±5%, ±3%, ±1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

When a compound is represented by a stoichiometric compositional formula (e.g., “LiCoO₂”), the stoichiometric compositional formula is only representative of the compound. The compound may have a non-stoichiometric composition. For example, when lithium cobalt oxide is expressed as “LiCoO₂”, unless otherwise specified, the lithium cobalt oxide is not limited to a composition ratio of “Li/Co/O=1/1/2”, and can include Li, Co and O in any composition ratio. Further, doping with trace elements, substitution, etc. can also be permitted.

“Spherical equivalent diameter” refers to the diameter of a sphere having the same volume as the volume of an object. In 30 objects (e.g., 30 particles), the volumes are each measured. The volume of the object can be determined, for example, by measuring the dimensions of the representative portion in a microscope image. For example, in the case of a cylinder (round bar), the diameter (thickness) and the height (length) can be measured. The average volume (arithmetic mean) of the 30 objects is determined. The sphere equivalent diameter is obtained by the following formula.

φ=2{V/π)(¾)}^{1/3}
φ: Ball equivalent diameter
V: Mean volume of the object
π: Circumferential ratio

The “average particle diameter” indicates a particle diameter in which the cumulative frequency from the side having the smaller particle diameter reaches 50% in the volume-based particle diameter distribution. The mean particle size is also referred to as “D50”. The average particle size can be measured by a laser diffraction method.

The “positive electrode current collector” indicates a member that exchanges electrons with the positive electrode composite material. The positive electrode current collector may be connected to an external terminal (positive electrode terminal). The positive electrode current collector may also function as an external terminal. The same applies to the negative electrode current collector.

Hereinafter, an application example to a “lithium ion battery” will be described. However, the lithium-ion battery is merely an example of a battery. The present embodiment can be applied to any battery system.

### Battery

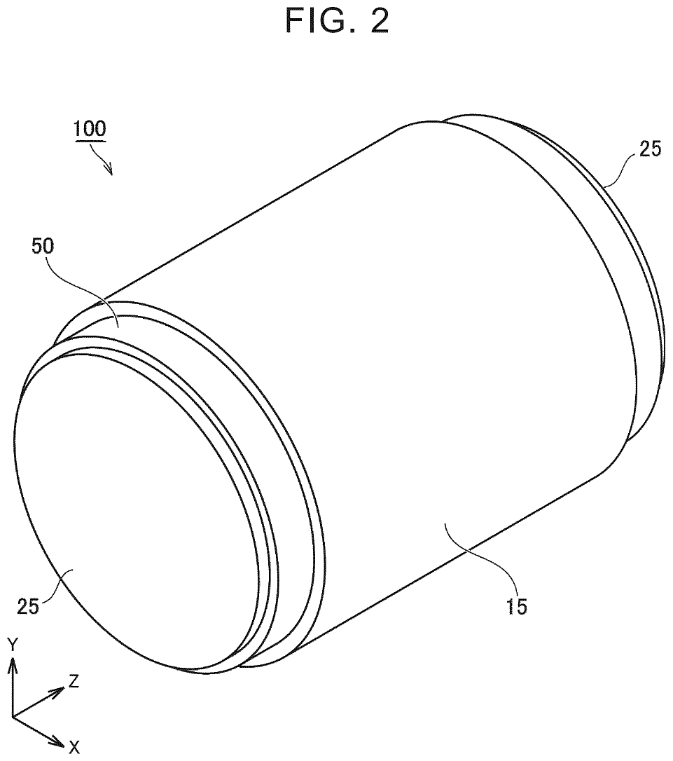

FIG. 2 is a schematic diagram illustrating an example of a battery according to the present embodiment. Hereinafter, the “battery in the present embodiment” may be abbreviated as “the present battery”. The battery 100 includes a power generation element 50 and a positive electrode current collector 25. The battery 100 may further include, for example, a negative electrode current collector 15, an electrolytic solution (not shown), an exterior body (not shown), and the like. The sheath may house the power generation element 50. The exterior body may be, for example, a metal container, a pouch made of a metal foil laminate film, or the like. The electrolytic solution may be impregnated into the power generation element 50.

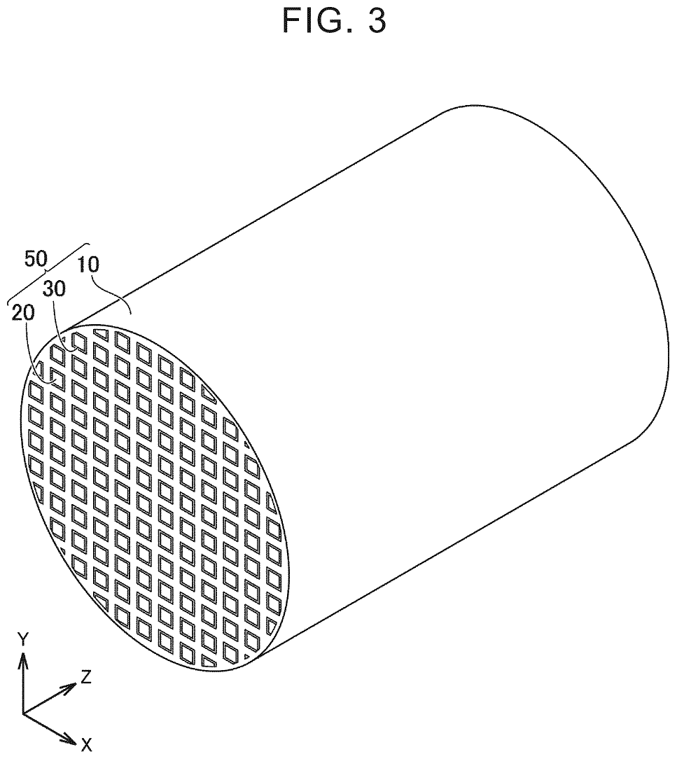

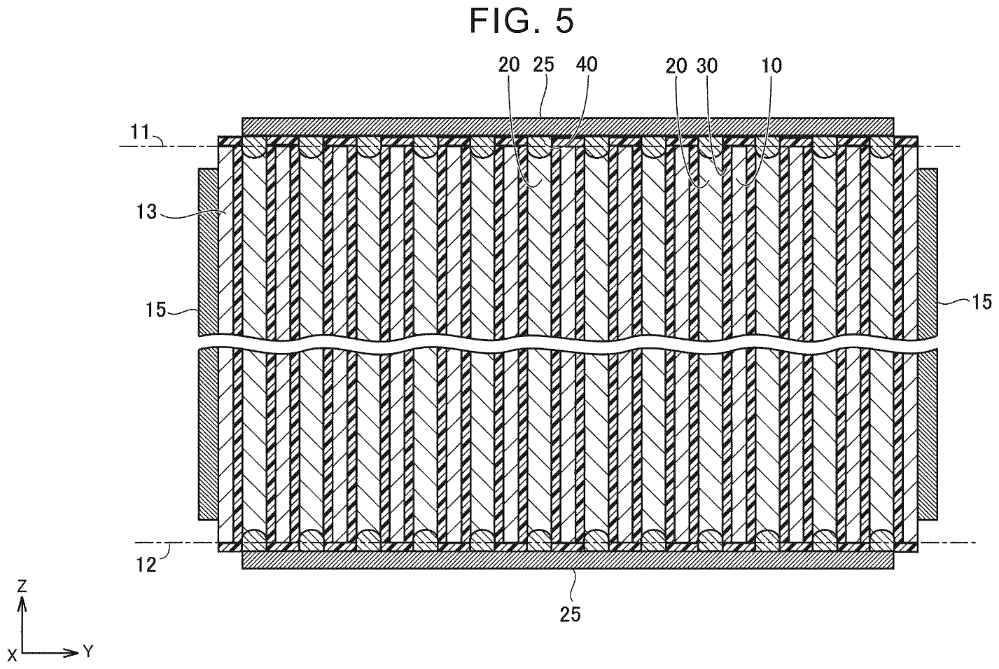

FIG. 3 is a schematic diagram of a power generation element according to the present embodiment. The power generation element 50 includes a honeycomb structure as a base material. The power generation element 50 includes a negative electrode composite material 10 (honeycomb structure), a positive electrode composite material 20, a separator layer 30, and a conductive layer 40 (see FIG. 5).

### Anode Composite Material

The negative electrode composite material 10 includes a negative electrode active material. The negative electrode active material may be a group of particles. The negative electrode active material may have an average particle diameter of, for example, 1 to 30 μm. The negative electrode composite material may further include, for example, a conductive material, a binder, and the like. The negative electrode composite material 10 may include, for example, 1 to 10% of a binder, 0 to 10% of a conductive material, and the remaining negative electrode active material in a mass fraction. The negative electrode active material may include an optional component. The negative electrode active material may include, for example, at least one selected from the group consisting of natural graphite, artificial graphite, soft carbon, hard carbon, silicon, silicon oxide, tin, tin oxide, and lithium titanate. The conductive material may include, for example, acetylene black (AB), carbon nanotube (CNT), and the like. The binder may include, for example, styrene-butadiene rubber (SBR), carboxymethyl cellulose (CMC), and the like.

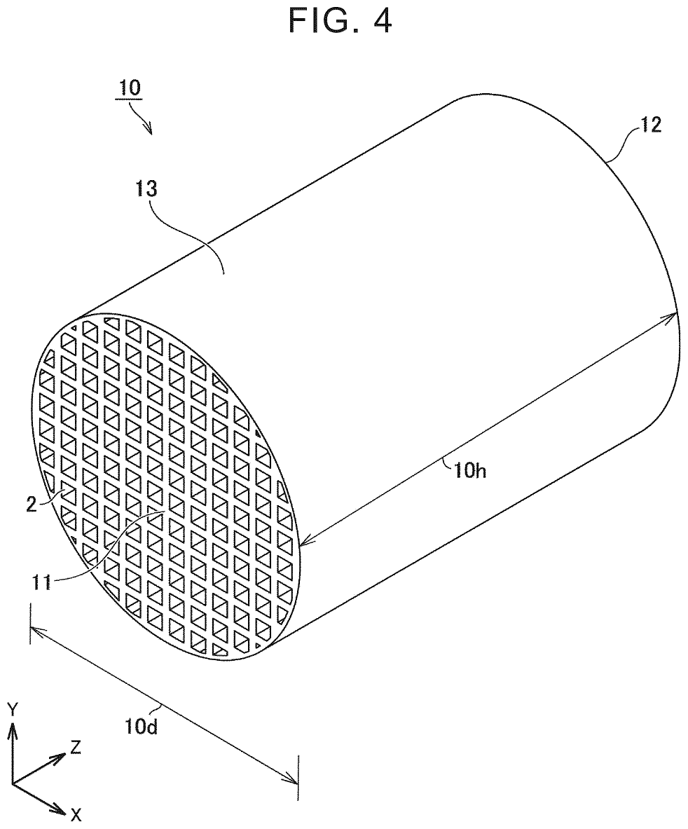

FIG. 4 is a schematic view showing an example of the negative electrode composite material in the present embodiment. The negative electrode composite material 10 is formed into a predetermined shape. The molded body may be porous. The external shape of the negative electrode composite material 10 is arbitrary. The outer shape of the negative electrode composite material 10 may be, for example, a columnar shape, a plate shape, or the like. The outer shape of the negative electrode composite material 10 may be, for example, a cylindrical shape, a prismatic shape, or the like.

The negative electrode composite material 10 may have, for example, a diameter 10d. Diameter 10d indicates the largest width in XY plane. The diameter 10d may be, for example, from 1 to 1000 mm. The negative electrode composite material 10 may have, for example, a height 10h. The height 10h indicates the largest width in YZ plane. The height 10h may be, for example, 1 to 1000 mm. The ratio of the height 10h to the diameter 10d may be, for example, from 0.1 to 10.

The negative electrode composite material 10 forms a honeycomb structure. A “honeycomb structure” may also be referred to as, for example, a “honeycomb core” or a “honeycomb formed body”. The honeycomb structure (negative electrode composite material 10) includes a first end surface 11, a second end surface 12, and a side wall 13. The second end surface 12 is a surface opposite to the first end surface 11. The second end surface 12 may be parallel to or non-parallel to the first end surface 11. Each of the first end surface 11 and the second end surface 12 may be independently a flat surface or a curved surface. The side wall 13 connects the first end surface 11 and the second end surface 12. The side wall 13 is formed over the entire periphery of the periphery of the first end surface 11 and the second end surface 12. For example, the negative electrode current collector 15 may be bonded to the side wall 13 (see FIGS. 2 and 5). Negative electrode current collector 15, for example, metal foil, metal sheet, it may include a metal wire or the like. The negative electrode current collector 15 may include, for example, Cu, Ni, stainless-steel, or the like.

A plurality of through holes 2 is formed in the negative electrode composite material 10. Each of the through holes 2 extends from the first end surface 11 to the second end surface 12. The extending direction of the through hole 2 may be parallel to the axial direction (Z-axis direction) of the negative electrode composite material 10. In a cross section (XY plane) perpendicular to the axial direction, the through holes 2 may be arranged regularly or irregularly. In XY plane, for example, the through hole 2 may be formed at a density of 0.1 to 10/mm². In XY plane, the cross-sectional shapes of the through holes 2 are arbitrary. The cross-sectional shape may be, for example, a circular shape or a polygonal shape. The cross-sectional shape may be, for example, 3 to 12 square. The cross-sectional shape may be, for example, a square shape or a square hexagonal shape.

A wall (a part of the negative electrode composite material 10) separating the through holes 2 from each other is also referred to as a “rib”. In XY plane, the ribs may extend, for example, in a mesh-like manner. The ribs may have a thickness of, for example, 100 to 300 μm.

### Separator Layer

FIG. 5 is a schematic cross-sectional view of a power generation element according to the present embodiment. The separator layer 30 covers at least a part of the inner wall of the through hole 2. The separator layer 30 is interposed between the negative electrode composite material 10 and the positive electrode composite material 20. The separator layer 30 separates the positive electrode composite material 20 from the negative electrode composite material 10. The separator layer 30 is Li ion-permeable. The separator layer 30 may be porous, for example. The electrolyte may permeate the separator layer 30.

The separator layer 30 may have a thickness of, for example, 10 to 100 μm. The separator layer 30 includes an insulating material. The separator layer 30 may include, for example, a ceramic particle group, a resin particle group, a polymer gel, a solid electrolyte, and the like. The separator layers 30 may include, for example, boehmite, polyvinylidene fluoride (PVDF), polyimide (PI), sulfide solid-electrolyte (Li₃PS₄), and the like.

For example, the separator layer 30 may extend so as to cover at least one of the first end surface 11 and the second end surface 12. The separator layer 30 may be partially different in composition. For example, the composition of the separator layer 30 may be different between the inside and the outside of the through hole 2. For example, the composition of the separator layer 30 may be different between a portion covering the inner wall of the through hole 2 and a portion covering the first end surface 11 (or the second end surface 12). For example, the portion covering the inner wall of the through hole 2 may include a ceramic particle group. For example, the portion covering the first end surface 11 (or the second end surface 12) may include a resin particle group.

### Positive Electrode Composite Material

The positive electrode composite material 20 includes a positive electrode active material. The positive electrode active material may be a group of particles. The positive electrode active material may have, for example, an average particle diameter of 1 to 30 μm. The positive electrode composite material 20 may further include, for example, a conductive material, a binder, and the like. The positive electrode composite material 20 may include, for example, 1 to 10% of a binder, 1 to 10% of a conductive material, and the remaining positive electrode active material in a mass fraction.

The positive electrode active material may include any component. The positive electrode active material may include, for example, at least one selected from the group consisting of lithium cobaltate, lithium nickelate, lithium manganate, lithium nickel cobalt manganate, lithium nickel cobalt aluminate, and lithium iron phosphate. The conductive material may include, for example, AB or the like. The binder may include, for example, PVDF or the like.

The positive electrode composite material 20 is disposed inside the through hole 2. The positive electrode composite material 20 may be porous. The positive electrode composite material 20 may be filled in the through hole 2. The positive electrode composite material 20 may have, for example, a columnar shape. The positive electrode composite material 20 may fill the through hole 2 without any gap. Part of the through hole 2 may remain unfilled. The positive electrode composite material 20 may have a layered shape. The positive electrode composite material 20 may be laminated on the separator layer 30. The positive electrode composite material 20 may extend along the inner wall of the through hole 2. For example, the positive electrode composite material 20, the separator layers 30, and the negative electrode composite material 10 may be arranged concentrically in XY plane.

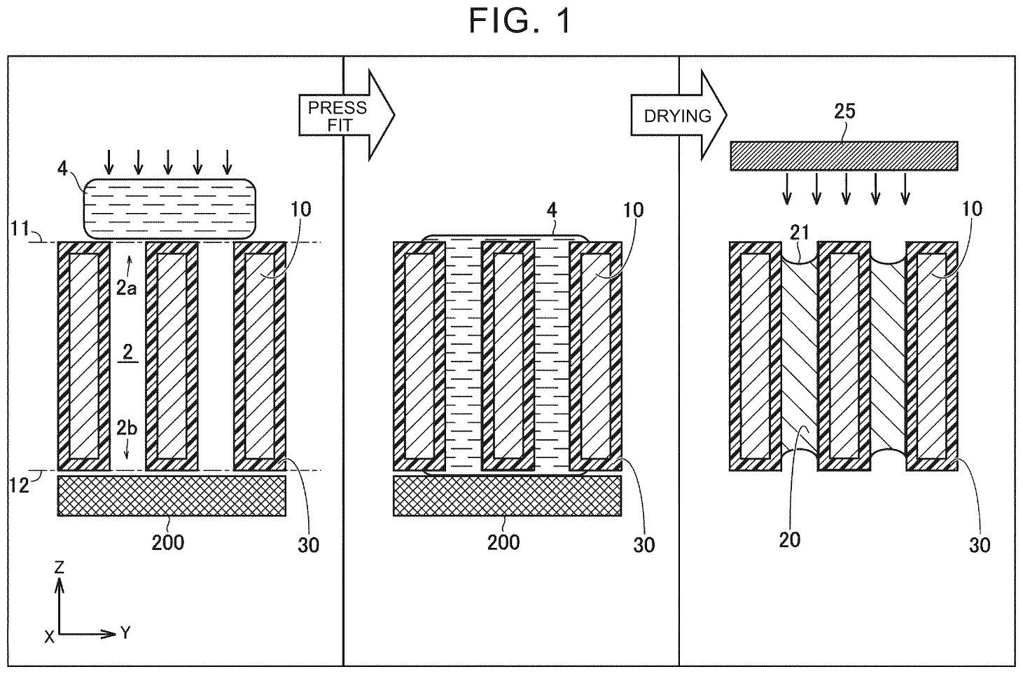

The positive electrode composite material 20 may include a recessed portion 21 (see FIG. 1). The recessed portion 21 is recessed from the first opening portion 2a or the second opening portion 2b toward the inside of the through hole 2. The recessed portion 21 may be formed by shrinkage of the positive electrode paste 4 when the positive electrode paste 4 is dried. The recessed portion 21 may have, for example, a mortar shape. The depth of the recessed portion 21 may be, for example, 0.1 to 1 times or 0.1 to 0.5 times the diameter of the through hole 2.

### Conductive Layer

The conductive layer 40 includes a conductive material. The conductive layer 40 may further include, for example, a binder, a positive electrode active material, and the like. However, the conductive layer 40 has a composition different from that of the positive electrode composite material 20. The mass fraction of the positive electrode active material in the conductive layer 40 is lower than the mass fraction of the positive electrode active material in the positive electrode composite material 20. The conductive layer 40 may not include a positive electrode active material. The conductive layer 40 may include, for example, 0.1 to 30% of a binder and the remainder of the conductive material by mass fraction. The mass fraction of the binder may be, for example, from 1 to 20%, or from 5 to 15%.

The mass ratio of the binder to the conductive material may be, for example, 0.2 or less. When the mass ratio of the binder to the conductive material is 0.2 or less, cracks in the separator layer 30 can be reduced. The mass ratio of the binder to the conductive material may be, for example, 0.1 or less. The mass ratio of the binder to the conductive material may be, for example, greater than 0.01, greater than or equal to 0.07, or greater than or equal to 0.1.

The conductive material has electronic conductivity. The conductive material may include, for example, at least one selected from the group consisting of a group of spherical carbon particles, a group of discotic carbon particles, and a group of rod-shaped carbon particles. Examples of the spherical carbon particle group include, for example, spheronized graphite. Examples of the rod-shaped carbon particles include carbon fibers such as milled fibers. In particular, since the conductive material includes the rod-shaped carbon particle group, the battery resistance is expected to be reduced. It is believed that the rod-shaped carbon particles may form an electron conduction path over a long distance. The rod-shaped carbon particles may have an average length (fiber length) of, for example, 50 to 500 μm, 150 to 250 μm, or 100 to 200 μm. The rod-shaped carbon particles may have an average diameter (fiber diameter) of, for example, 1 to 30 μm, or 5 to 15 μm.

The conductive material may have a sphere equivalent diameter of 10 μm or more. When the sphere equivalent diameter is 10 μm or more, the conductive material tends to hardly penetrate into the separator layer 30. The sphere equivalent diameter may be, for example, 11 μm or more, 20 μm or more, or 24 μm or more. The sphere equivalent diameter may be, for example, 38 μm or less, or 30 μm or less.

The conductive layer 40 connects the positive electrode composite material 20 inside the through hole 2 and the positive electrode current collector 25 outside the through hole 2. For example, the conductive layers 40 may be disposed so as to block at least one of the first opening portion 2a and the second opening portion 2b. For example, the conductive layers 40 may be disposed so as to block one of the first opening portion 2a and the second opening portion 2b. For example, the conductive layers 40 may be disposed so as to block both the first opening portion 2a and the second opening portion 2b. For example, the conductive layer 40 may extend to cover a portion of the separator layer 30. For example, the conductive layer 40 may extend to cover the entire first end surface 11. For example, the conductive layer 40 may extend to cover the entire second end surface 12.

### Positive Electrode Current Collector

The positive electrode current collector 25 is disposed outside the through hole 2. The positive electrode current collector 25 may be disposed on one of the first end surface 11 and the second end surface 12. The positive electrode current collector 25 may be disposed on both the first end surface 11 and the second end surface 12. The positive electrode current collector 25 may be bonded to the conductive layer 40. Positive electrode current collector 25, for example, metal foil, metal sheet, it may include a metal wire or the like. The positive electrode current collector 25 may include, for example, Al, Al, stainless-steel, or the like. The positive electrode current collector 25 may have a thickness of, for example, 5 to 50 μm.

### Electrolytic Solution

The battery 100 may include an electrolytic solution. The electrolyte solution includes a supporting electrolyte and a solvent. The supporting electrolyte is dissolved in a solvent. The supporting electrolyte may comprise any component. The supporting electrolyte may comprise, for example, at least one selected from the group consisting of LiPF₆, LiBF₄, and Li(FSO₂)₂N. The level of the supporting electrolyte may be, for example, 0.5 to 2 mol/kg.

The solvent is aprotic. The solvent may comprise any component. The solvents may include, for example, at least one selected from the group consisting of ethylene carbonate (EC), propylene carbonate (PC), butylene carbonate (BC), ethyl methyl carbonate (EMC), dimethyl carbonate (DMC), and diethyl carbonate (DEC). The electrolyte solution may further include an optional additive in addition to the supporting electrolyte and the solvent.

### Battery Manufacturing Method

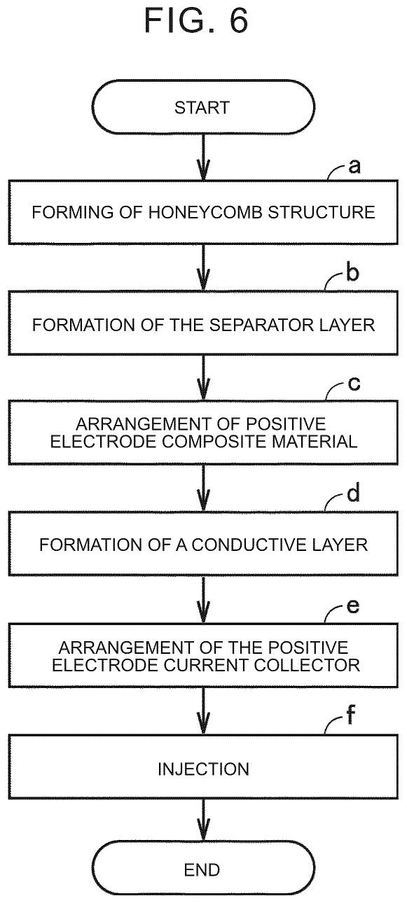

FIG. 6 is a schematic flowchart of a method of manufacturing a battery according to the present embodiment. Hereinafter, the “method for manufacturing a battery in the present embodiment” may be abbreviated as “the present manufacturing method”. The manufacturing method includes “(a) forming a honeycomb structure”, “(b) forming a separator layer”, “(c) arranging a positive electrode composite material”, “(d) forming a conductive layer”, and “(e) arranging a positive electrode current collector”. The manufacturing method may further include, for example, “(f) injection” and the like.

### (a) Forming of Honeycomb Structure

The method includes forming a negative electrode composite material into a honeycomb structure. For example, the negative electrode composite material may be formed by an extrusion molding method.

For example, a negative electrode paste is prepared by dispersing a negative electrode composite material in a dispersion medium. For example, an appropriate dispersion medium may be selected according to the type of binder and the like. The dispersing medium may contain, for example, water, N-methyl-2-pyrrolidone (NMP), butyl butyrate, tetralin, and the like. The same applies to the pastes described below.

A mold is prepared. The mold has an extrusion port (die). The extrusion port corresponds to the shape of the honeycomb structure. When the negative electrode paste is extruded from the extrusion port, a molded body is formed. The molded body may be dried to form a honeycomb structure.

### (b) Formation of the Separator Layer

The manufacturing method includes coating at least a portion of the inner wall of the through hole 2 with the separator layer 30. The separator layer 30 may be formed by, for example, a suction method.

For example, a separator paste is prepared by dispersing an insulating material and a binder in a dispersion medium. The separator paste may adhere to the inner wall of the through hole 2 by sucking the separator paste from the first opening portion 2a or the second opening portion 2b. For example, the separator paste may be sucked by a vacuum pump. The separator paste may be dried to form the separator layer 30.

The separator layer 30 may also be formed on the first end surface 11 and the second end surface 12. For example, an insulating material may be attached to the first end surface 11 and the second end surface 12 by an electrodeposition method.

### (c) Arrangement of Positive Electrode Composite Material

This manufacturing process includes disposing the positive electrode composite material 20 inside the through hole 2 by pushing the positive electrode paste 4 into the through hole 2 from the first opening portion 2a or the second opening portion 2b.

For example, the positive electrode paste 4 is prepared by dispersing the positive electrode composite material in a dispersion medium. For example, the positive electrode paste 4 and the honeycomb structure are disposed in the cylinder. In the cylinder, the positive electrode paste 4 may be press-fitted into the through hole 2 by the piston. By drying the positive electrode paste, the positive electrode composite material 20 can be disposed in the through hole 2.

The positive electrode paste 4 is filled into the through hole 2 from the first opening portion 2a or the second opening portion 2b. In FIG. 1, for example, the positive electrode paste 4 is inserted from the first opening portion 2a. For example, the porous filters 200 may be disposed on the outlet side (the second opening portion 2b side). The porous filter 200 may have an opening such that the dispersion medium passes therethrough and the solid content (positive electrode active material or the like) does not pass therethrough. The porous filter 200 may be, for example, a metal mesh, a porous body, or the like. By disposing the porous filter 200 on the outlet side, it is expected that the positive electrode composite material 20 is densely filled.

### (d) Formation of a Conductive Layer

The method includes forming the conductive layers 40 by applying a conductive paste to at least one of the first opening portion 2a and the second opening portion 2b. The conductive layer 40 is formed so as to be in contact with the positive electrode composite material 20 inside the through hole 2.

For example, a conductive paste is prepared by dispersing a conductive material and a binder in a dispersion medium. The conductive paste may be applied so as to cover at least one of the first opening portion 2a and the second opening portion 2b. For example, a conductive paste may be applied to at least one of the first end surface 11 and the second end surface 12. The conductive paste may be dried to form the conductive layer 40.

For example, when the positive electrode paste 4 is pushed in from the first opening portion 2a (that is, when the first opening portion 2a is the inlet side), the conductive paste may be applied to at least the second opening portion 2b (the outlet side). This is because shrinkage of the positive electrode paste 4 is likely to occur on the outlet side.

### (e) Arrangement of the Positive Electrode Current Collector

The manufacturing method includes bonding the positive electrode current collector 25 to the conductive layer 40 from the outside of the through hole 2. The positive electrode current collector 25 may be bonded to the conductive layer 40 by any method. For example, the positive electrode current collector 25 may be crimped to the conductive layer 40. For example, the positive electrode current collector 25 may be bonded to the conductive layer 40 by a conductive paste.

The manufacturing method may include bonding the negative electrode current collector 15 to the negative electrode composite material 10. For example, the sheet-shaped negative electrode current collector 15 may be attached to the side wall 13 of the honeycomb structure. For example, the linear negative electrode current collector 15 may be wound around the side wall 13 of the honeycomb structure.

### (f) Injection

The manufacturing method may include permeating the separator layer 30 with an electrolytic solution. For example, an exterior body (not shown) is prepared. The power generation element 50 is housed in the exterior body. The electrolyte is injected into the exterior body. After the injection of the electrolyte solution, the exterior body is sealed. The electrolyte may permeate the separator layer 30. As described above, the battery 100 can be manufactured.

### Manufacture of Test Cells

Test cells according to 14 were manufactured from No. 1 as follows. Hereinafter, for example, the “test cell according to No. 1” may be abbreviated as “No. 1”.

### No. 1

### (a) Forming of Honeycomb Structure

The following materials were prepared.
Negative electrode active material: Natural graphite (average particle diameter: 15 μm)
Binder: CMC
Dispersion medium: ion-exchanged water

A negative electrode paste was prepared by mixing 100 parts by mass of the negative electrode active material, 10 parts by mass of the binder, and 60 parts by mass of the dispersion medium. The negative electrode paste was extruded from the mold to form a molded body. The molded body was dried at 120° C. for 3 hours to form a honeycomb structure. The honeycomb structure had the following structure.

Outer: Cylindrical (Diameter: 20 mm, Height: 10 mm)
Arrangement of through holes: regular (honeycomb-shaped)
Cross-sectional shape of through hole: regular hexagonal shape (length of 1 sides: 700 μm, thickness of rib: 200 μm)

### (b) Formation of the Separator Layer

The following materials were prepared.
Insulating material: boehmite (average particle diameter: 0.5 μm)
Binder: PVDF (product name KF polymer, grade #8500, manufactured by Kureha)
Dispersion medium: NMP

A separator paste was prepared by mixing 57 parts by mass of the insulating material, 5 parts by mass of the binder, and 38 parts by mass of the dispersion medium. A separator paste of 3 to 5 g was placed on the first end surface of the honeycomb structure. The vacuum pump sucked the separator paste into the through hole from the second end surface side. As a result, the separator paste adhered to the inner wall of the through hole. The honeycomb structure was dried at 120° C. for 15 minutes. As a result, a separator layer (boehmite layer) was formed. The average thickness of the separator layer was measured by light microscopy. The average thickness was 65 μm.

An electrodeposition coating material (product name “Elecoat PI”, manufactured by Shimizu Corporation) was prepared. The electrodeposition coating material contained an insulating material (polyimide) and a dispersion medium (water). A Ni flat wire (thickness: 50 micrometers, width: 3 mm) was prepared. A Ni flat wire was wrapped around the side wall of the honeycomb structure. Ni flat wire is connected to the power supply. The honeycomb structure was immersed in the electrodeposition paint. 30V was applied for 2 minutes using the honeycomb structure (negative electrode composite material) as the cathode and the working electrode as the anode. Thus, the first end surface and the second end surface were coated on the separator layer (polyimide layer). After electrodeposition, the honeycomb structure was lightly cleaned with water to remove excess electrodeposition paint. After washing, the honeycomb structure was heat treated at 180° C. for 1 hour.

### (c) Arrangement of Positive Electrode Composite Material

The following materials were prepared.
Positive electrode active material: lithium cobaltate (average particle diameter: 10 μm)
Conductive material: acetylene black
Binder: PVDF (KF Polymer, Grade #1300, manufactured by Kureha Co., Ltd.)
Dispersion medium: NMP

A positive electrode paste was prepared by mixing 64 parts by mass of the positive electrode active material, 4 parts by mass of the conductive material, 2 parts by mass of the binder, and 30 parts by mass of the dispersion medium. A plastic pipe was prepared. The pipe had an inlet end and an outlet end. A honeycomb structure was fixed to the outlet end side. A plate-shaped metal filter was prepared. The pipe was fixed upright on the metal filter. The outlet end was in contact with the metal filter. A 3.5 g of positive electrode was injected from the inlet end of the tube. A cylinder (round bar) was inserted into the pipe from the inlet end. The cylinder had a diameter (cylinder diameter) substantially the same as the inner diameter of the pipe. The cylinder was pushed in by the pressing force of 300 N. As a result, the positive electrode paste was pushed into the through hole. When the pushing force exceeds 500 N, the pushing of the cylinder is stopped. The honeycomb structure was removed from the pipe. The honeycomb structure was vacuum dried at 120° C. for 30 minutes. As a result, the positive electrode composite material was disposed inside the through hole.

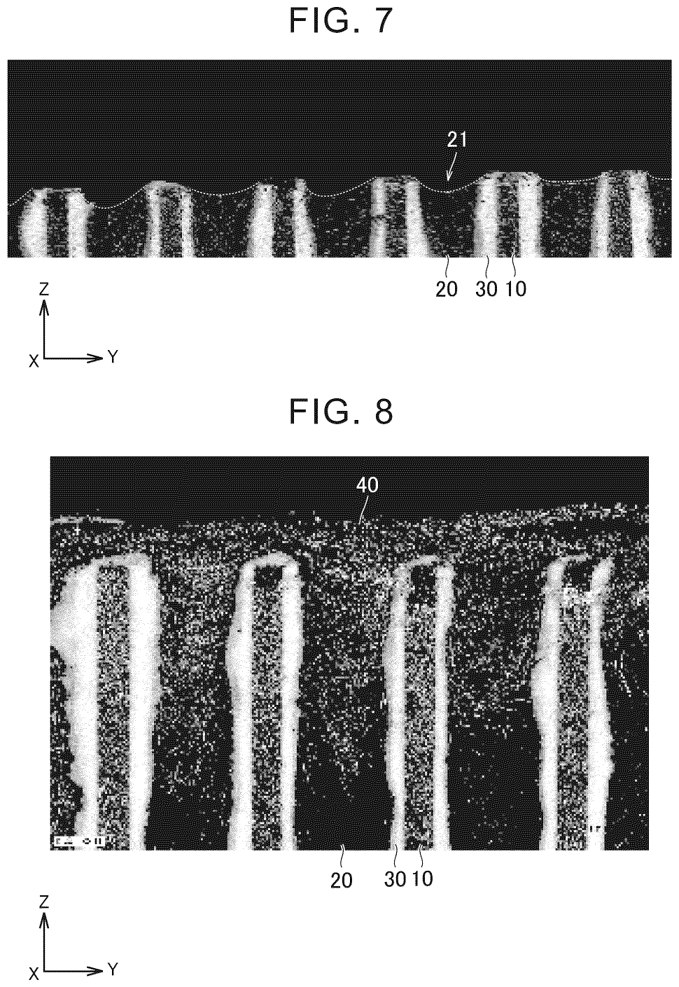

FIG. 7 is a first optical micrograph showing a manufacturing process of the battery according to the present embodiment. FIG. 7 shows a cross section of the honeycomb structure after drying of the positive electrode paste (opening and its periphery). Since the positive electrode paste shrinks during drying, the recessed portion 21 is formed at the tip end of the positive electrode composite material 20.

### (d) Formation of a Conductive Layer

The following materials were prepared.
Conductive material: rod-shaped carbon particle group (average length: 100 μm, average diameter: 10 μm, sphere conversion diameter: 30 μm)
Binder: PVDF (KF Polymer, Grade #1300, manufactured by Kureha Co., Ltd.)
Dispersion medium: NMP

A conductive paste was prepared by mixing 70 parts by mass of a conductive material, 7 parts by mass of a binder, and 23 parts by mass of a dispersion medium. Conductive paste was applied to both the first end surface and the second end surface. The conductive paste was applied to be pressed by the spatula. Further, the conductive paste was formed to be smooth by the spatula. After application of the conductive paste, the honeycomb structure was vacuum dried at 120° C. for 30 minutes. Thus, a conductive layer was formed.

FIG. 8 is a second optical micrograph showing a manufacturing process of the battery according to the present embodiment. The conductive layer 40 is formed so as to fill the recessed portion 21 (FIG. 7).

### Insulation Test

By the tester, the DC resistance was measured between the conductive layer and the side wall of the honeycomb structure (the exposed portion of the negative electrode composite material). In Tables 1 below, “pass” indicates that the DC resistance (insulation resistance) was 1 MΩ or more. “fail” indicates that the DC resistivity was less than 1 MΩ. In samples with “pass”, the DC resistivity exceeded the measured limits of the tester.

### (e) Arrangement of the Positive Electrode Current Collector

As a positive electrode current collector, two Al foils (diameter: 15 mm, thickness: 15 micrometers) were prepared. The positive electrode current collector was adhered to the conductive layer by the conductive paste used to form the conductive layer. The positive electrode current collector was bonded to both the conductive layer on the first end surface and the conductive layer on the second end surface, respectively. After the placement of the positive electrode current collector, the honeycomb structure was dried at 120° C. for 15 minutes.

### Arrangement of the Negative Electrode Current Collector

As the negative electrode current collector, a Ni flat wire (thickness: 50 micrometers, width: 3 mm) was prepared. A negative electrode current collector was wound around the side wall (outer peripheral surface) of the honeycomb structure over one circumference.

Stainless steel lead tabs were prepared as external terminals. A lead tab was welded to each of the positive electrode current collector and the negative electrode current collector. As described above, a power generation element was formed.

### (f) Injection

Pouches made of aluminum laminated film were prepared as the outer body. A power generation element was housed in the outer casing. The electrolyte of 5 g was injected into the outer casing. After the injection of the electrolyte solution, the exterior body was vacuum sealed. The electrolyte had the following composition: As described above, the test battery was manufactured.

### Electrolyte Composition

Support electrolyte: LiPF₆ (density: 1 mol/kg)
Solvent: EC/EMC/DMC=1/1/1 (by volume)
Measuring Battery Resistance

Charging, pausing, and discharging under the following conditions were performed sequentially. “CC” indicates a constant current system. “CV” indicates a constant-voltage system. “CCCV” indicates a constant-current-constant-voltage system.

Charge: CCCV, CC current=40 mA, CV voltage=4.2 V, stop current=10 mA
Pause: 10 minutes
Discharge: CCCV, CC current=40 mA, CV voltage=3 V, stop current=10 mA

After the initial charging and discharging, the voltage of the test battery was adjusted according to the following conditions.
Charge: CCCV, CC current=40 mA, CV voltage=3.85 V, stop current=10 mA

After regulation, the test cell was discharged for 1 second at CC current of 200 mA. The voltage drop amount after one second from the start of discharge was measured. The battery resistance was obtained from the voltage drop amount and the discharge current.

### No. 2

Test cells were produced in the same manner as No. 1, except that the rod-shaped carbon-particle group (mean length: 200 μm, sphere equivalent diameter: 38 μm) was used as the conductive material.

### No. 3

Test cells were produced in the same manner as No. 1, except that the rod-shaped carbon-particle group (mean length: 50 μm, sphere equivalent diameter: 24 μm) was used as the conductive material.

### No. 4, 5, 12 to 13

Test cells were produced in the same manner as in No. 1, except that the weight ratio of the binder to the conductive material (see Table 1 below) was changed in the conductive paste.

### No. 6

Test cells were produced in the same manner as No. 1, except that spherical carbon particles (spheroidal graphite, mean particle diameter: 20 μm, spheroidal diameter: 20 μm) were used as the conductive material instead of rod-shaped carbon particles.

### No. 7

Test cells were produced in the same manner as No. 1, except that a group of spherical carbon particles (spheroidal graphite, mean particle diameter: 11 μm, spheroidal diameter: 11 μm) was used as the conductive material instead of the group of rod-shaped carbon particles.

### No. 8

Test cells were fabricated in the same manner as No. 1 except that the conductive pastes were applied only to the first end surface. That is, the conductive layer was formed only in the first opening portion of the first opening portion and the second opening portion. In the present embodiment, the positive electrode paste is pushed from the first opening portion. Thus, the first opening portion is the inlet side (insertion side) and the second opening portion is the outlet side.

### No. 9

Test cells were fabricated in the same manner as No. 1 except that the conductive pastes were applied only to the second end surface. That is, the conductive layer was formed only in the second opening portion (the outlet side) of the first opening portion and the second opening portion.

### No. 10

Test cells were fabricated in the same manner as No. 1 except that the conductive layers were not formed and the positive current collector was directly affixed to the first and second end surfaces.

### No. 11

Test cells were produced in the same manner as No. 4, except that amorphous carbon material (carbon black, sphere-equivalent diameter: less than 1 μm) was used as the conductive material instead of rod-shaped carbon grains.

### No. 14

In the conductive paste, the mass ratio of the binder to the conductive material was changed to 0.01, and the conductive paste was applied. However, it is difficult to form the conductive layer. In No. 15, the production of the test cells was discontinued.

TABLE 1

| | Conductive layer | | | | | |
|---|---|---|---|---|---|---|
| | | | Binder/conductive | | Evaluation | |
| | Conductive material | | material | | | Battery |
| | Particle | Ball equivalent | Mass ratio | | Insulation | resistance |
| No. | shape | diameter [μm] | [—] | Location | test | [Ω] |
| 1 | Rod | 30 | 0.1 | first opening | pass | 1.4 |
| | shape | | | portion and | | |
| | | | | second opening | | |
| | | | | portion | | |
| 2 | Rod | 38 | 0.1 | first opening | pass | 1.3 |
| | shape | | | portion and | | |
| | | | | second opening | | |
| | | | | portion | | |
| 3 | Rod | 24 | 0.1 | first opening | pass | 1.6 |
| | shape | | | portion and | | |
| | | | | second opening | | |
| | | | | portion | | |
| 4 | Rod | 30 | 0.2 | first opening | pass | 1.5 |
| | shape | | | portion and | | |
| | | | | second opening | | |
| | | | | portion | | |
| 5 | Rod | 30 | 0.07 | first opening | pass | 1.3 |
| | shape | | | portion and | | |
| | | | | second opening | | |
| | | | | portion | | |
| 6 | Globular | 20 | 0.1 | first opening | pass | 3.1 |
| | shape | | | portion and | | |
| | | | | second opening | | |
| | | | | portion | | |
| 7 | Globular | 11 | 0.1 | first opening | pass | 3 |
| | shape | | | portion and | | |
| | | | | second opening | | |
| | | | | portion | | |
| 8 | Rod | 30 | 0.1 | first opening | pass | 2.7 |
| | shape | | | portion | | |
| | | | | (inlet side) | | |
| 9 | Rod | 30 | 0.1 | second opening | pass | 1.9 |
| | shape | | | portion | | |
| | | | | (outlet side) | | |
| 10 | — | — | — | — | pass | 31.3 |
| 11 | Indefinite | <1 | 0.2 | first opening | fail | — |
| | form | | | portion and | | |
| | | | | second opening | | |
| | | | | portion | | |
| 12 | Rod | 30 | 0.3 | first opening | fail | — |
| | shape | | | portion and | | |
| | | | | second opening | | |
| | | | | portion | | |
| 13 | Rod | 30 | 0.42 | first opening | fail | — |
| | shape | | | portion and | | |
| | | | | second opening | | |
| | | | | portion | | |
| 14 | Rod | 30 | 0.01 | first opening | — | — |
| | shape | | | portion and | | |
| | | | | second opening | | |
| | | | | portion | | |

### Results

When the conductive layers are formed between the positive electrode composite material and the positive electrode current collector, the cell resistivity tends to be greatly reduced (see No. 1 10 in Table 1).

When the sphere equivalent diameter decreases, the insulating resistivity tends to decrease (see No. 1, 11 in Table 1 above). It is considered that the conductive material penetrates into the separator layer, so that a short circuit path can be formed.

As the mass-ratio of the binder to the conductive material increases, the insulating resistivity tends to decrease (see No. 1, 13 and 14 in Table 1). It is considered that when the conductive paste is dried, shrinkage stress is generated, and thus cracks may occur in the separator layer.

When the rod-shaped carbon particles are used as compared to when the spherical carbon particles are used, the cell resistivity tends to be reduced (see No. 1 3, 6, and 7 in Table 1 above). It is considered that the rod-shaped carbon particles may form a long-distance conductive path.

The sample in which the conductive layer is disposed on both the inlet side (first opening portion) and the outlet side (second opening portion) tends to be more effective in reducing the cell resistivity than the sample in which the conductive layer is disposed on the inlet side or the outlet side (see No. 1 8 and 9 in Table 1).

A sample in which a conductive layer is disposed on the outlet side tends to have a greater reduction in cell resistivity than a sample in which a conductive layer is disposed on the inlet side (see No. 8, 9 in Table 1). It is considered that shrinkage of the positive electrode paste is likely to occur at the outlet side during drying.

What is claimed is:

1. A battery comprising:
a negative electrode composite material containing a negative electrode active material;
a separator layer;
a positive electrode composite material containing a positive electrode active material;
a conductive layer containing a conductive material; and
a positive electrode current collector, wherein
the negative electrode composite material forms a honeycomb structure,
the honeycomb structure includes a first end surface, a second end surface, and a side wall,
the second end surface is a surface opposite to the first end surface,
the side wall connects the first end surface and the second end surface,
a plurality of through holes extending from the first end surface to the second end surface is provided,
each of the through holes includes a first opening portion that is open to the first end surface, and a second opening portion that is open to the second end surface,
the separator layer covers at least a portion of an inner wall of the through hole,
the separator layer separates the positive electrode composite material from the negative electrode composite material,
the positive electrode composite material is disposed on an inside of the through hole,
the conductive layer has a different composition from a composition of the positive electrode composite material,
the positive electrode current collector is disposed outside the through hole, and
the conductive layer connects the positive electrode composite material and the positive electrode current collector.

2. The battery according to claim 1, wherein the conductive layer is disposed so as to close at least one of the first opening portion and the second opening portion.

3. The battery according to claim 1, wherein:
the positive electrode composite material includes a recessed portion; and
the recessed portion is recessed from the first opening portion or the second opening portion toward the inside of the through hole.

4. The battery according to claim 1, wherein the conductive material includes at least one selected from the group consisting of a spherical carbon particle group, a discotic carbon particle group, and a rod-shaped carbon particle group.

5. The battery according to claim 1, wherein the conductive material has a sphere equivalent diameter of 10 μm or more.

6. The battery according to claim 1, wherein:
the conductive layer further contains a binder; and
a mass ratio of the binder to the conductive material is 0.2 or less.

7. The battery according to claim 1, wherein the conductive layer does not contain the positive electrode active material.

8. The battery according to claim 1, wherein the conductive layer is disposed so as to close the first opening portion or the second opening portion.

9. The battery according to claim 1, wherein the conductive layer is disposed so as to close the first opening portion and the second opening portion.

10. A method of manufacturing a battery using a honeycomb structure as a base material, the honeycomb structure including a first end surface, a second end surface, a side wall, and a plurality of through holes, the second end surface being a surface opposite to the first end surface, the side wall connecting the first end surface and the second end surface, the through holes extending from the first end surface to the second end surface, each of the through holes including a first opening portion that is open to the first end surface and a second opening portion that is open to the second end surface, the method comprising executing, in the following order, processes including:
(a) forming a negative electrode composite material containing a negative electrode active material into the honeycomb structure;
(b) covering at least a portion of an inner wall of the through hole by a separator layer;
(c) disposing a positive electrode composite material inside the through hole by pushing a positive electrode paste into the through hole from the first opening portion or the second opening portion, the positive electrode composite material containing a positive electrode active material;
(d) forming a conductive layer in contact with the positive electrode composite material by applying a conductive paste to at least one of the first opening portion and the second opening portion; and
(e) adhering a positive electrode current collector to the conductive layer from an outside of the through hole, the conductive layer containing a conductive material and having a composition different from a composition of the positive electrode composite material.

11. The method according to claim 10, wherein:
the positive electrode paste is pushed into the through hole from the first opening portion; and
the conductive layer is formed by applying the conductive paste to at least the second opening portion.
